(19) United States
(12) Patent Application Publication
(10) Pub. No.: US 2026/0171772 A1
(43) Pub. Date: Jun. 18, 2026

(54) EXTERIOR MATERIAL AND WIRE HARNESS

(71) Applicant: YAZAKI CORPORATION, Tokyo (JP)

(72) Inventors: Masaru Kiuchi, Susono-shi (JP); Tetsuya Nagumo, Susono-shi (JP)

(21) Appl. No.: 19/405,245

(22) Filed: Dec. 1, 2025

(30) Foreign Application Priority Data
Dec. 16, 2024 (JP) 2024-219668

(51) Int. Cl. H02G 3/04; B60R 16/02

(52) U.S. Cl. CPC H02G 3/0468; B60R 16/0207

(57) ABSTRACT

An exterior material is a sheet formed with diamond-shaped recesses in a regular and adjacent arrangement in a width direction and a longitudinal direction, and is formed in a tubular shape by being bent in the width direction. The recesses are each formed in a square pyramid shape, and includes a first valley portion extending along the width direction and a second valley portion extending along the longitudinal direction. The first valley portion and the second valley portion intersect at an apex of the square pyramid shape. Four interior angles of each of the recesses are all right angles.

### CROSS-REFERENCE TO RELATED APPLICATIONS

This application is based on and claims priority under 35 USC 119 from Japanese Patent Application No. 2024-219668 filed on Dec. 16, 2024, the contents of which are incorporated herein by reference.

### TECHNICAL FIELD

The present disclosure relates to an exterior material and a wire harness.

BACKGROUND ART

As an exterior material of a wire harness, there is known a sheet-shaped exterior material in which recesses are formed by embossing in a regular and adjacent arrangement (for example, see Patent Literatures 1 to 4). Exterior materials described in Patent Literatures 1 to 4 are bent in a width direction and formed in a tubular shape. In the exterior materials described in Patent Literatures 1 and 2, a horizontal crease is formed in each recess along the width direction of the exterior materials, so that flexibility of the exterior material in a longitudinal direction is increased.

### Citation List

### Patent Literature

Patent Literature 1: JP2014-147183A
Patent Literature 2: JP2014-147184A
Patent Literature 3: JP 2016-025821A
Patent Literature 4: JP2016-025822A

### SUMMARY OF INVENTION

The exterior materials described in Patent Literatures 1 to 4 are formed into a tubular shape by heat molding or by being bent in the width direction by human power. Here, when the exterior materials are formed in a tubular shape by being bent in the width direction by human power, a force to return to a sheet shape acts on the exterior materials. Here, in the exterior materials described in Patent Literatures 1 and 2, since a horizontal crease is formed in each recess along the width direction of the exterior materials, flexibility of the exterior materials in the width direction is reduced. For this reason, it is necessary to provide multiple fixing portions on the exterior materials to prevent an electric wire from being exposed due to the exterior materials being opened in a sheet shape.

In view of the above circumstances, an object of the present disclosure is to provide an exterior material and a wire harness that can restrict a force to return to a sheet shape after the exterior material is formed into a tubular shape by being bent in a width direction, and can increase flexibility of the exterior material in a longitudinal direction.

An exterior material of the present disclosure is a sheet formed with diamond-shaped recesses in a regular and adjacent arrangement in a width direction and a longitudinal direction, and is formed in a tubular shape by being bent in the width direction. The recesses are each formed in a square pyramid shape, and includes a first valley portion extending along the width direction and a second valley portion extending along the longitudinal direction. The first valley portion and the second valley portion intersect at an apex of the square pyramid shape. Four interior angles of each of the recesses are all right angles.

A wire harness of the present disclosure includes an exterior material that is a sheet formed with diamond-shaped recesses in a regular and adjacent arrangement in a width direction and a longitudinal direction and that is formed in a tubular shape by being bent in the width direction, and an electric wire inserted through the exterior material. The recesses are each formed in a square pyramid shape, and a first valley portion extending along the width direction and a second valley portion extending along the longitudinal direction. The first valley portion and the second valley portion intersect at an apex of the square pyramid shape. Four interior angles of each of the recesses are all right angles.

According to the present disclosure, it is possible to provide an exterior material and a wire harness that can restrict a force to return to a sheet shape after the exterior material is formed into a tubular shape by being bent in a width direction, and can increase flexibility of the exterior material in a longitudinal direction.

### BRIEF DESCRIPTION OF DRAWINGS

FIG. 1 is a perspective view illustrating a wire harness according to an embodiment of the present disclosure;

FIG. 2 is a plan view illustrating the wire harness illustrated in FIG. 1;

FIG. 3 is a cross-sectional view illustrating the wire harness illustrated in FIG. 1;

FIG. 4 is a plan view illustrating the exterior material illustrated in FIG. 1 in a spread state; and

FIG. 5 is a plan view illustrating an exterior material according to a comparative example in a spread state.

### DESCRIPTION OF EMBODIMENTS

Hereinafter, the present disclosure will be described with reference to a preferred embodiment. The present disclosure is not limited to the embodiment to be described below, and the embodiment to be described below can be appropriately changed within a scope not departing from the spirit of the present disclosure. In the embodiment to be described below, a part of configurations may be not described or illustrated in the drawings, and regarding details of the omitted techniques, publicly known or well-known techniques will be appropriately applied as long as there is no contradiction with contents to be described below.

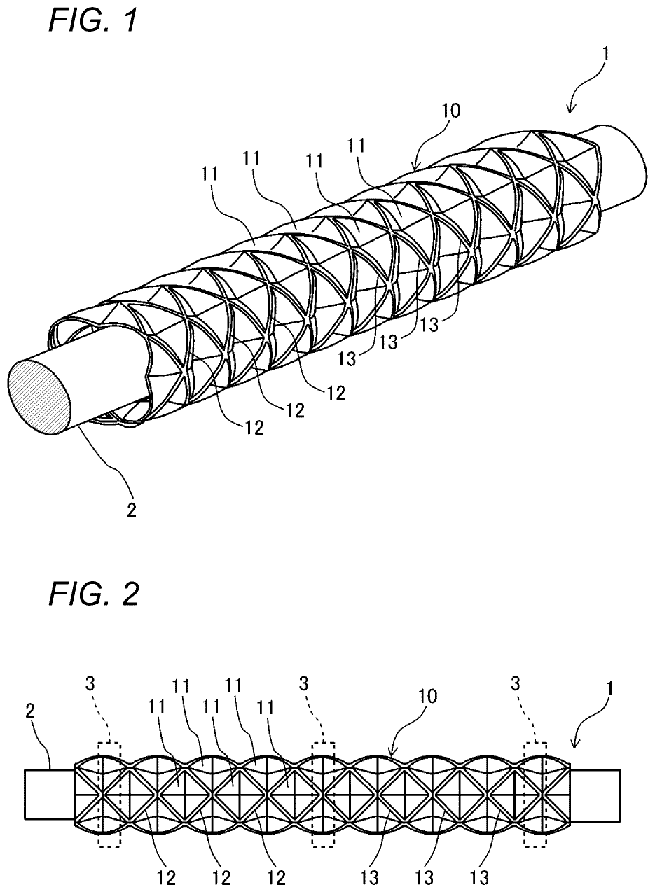

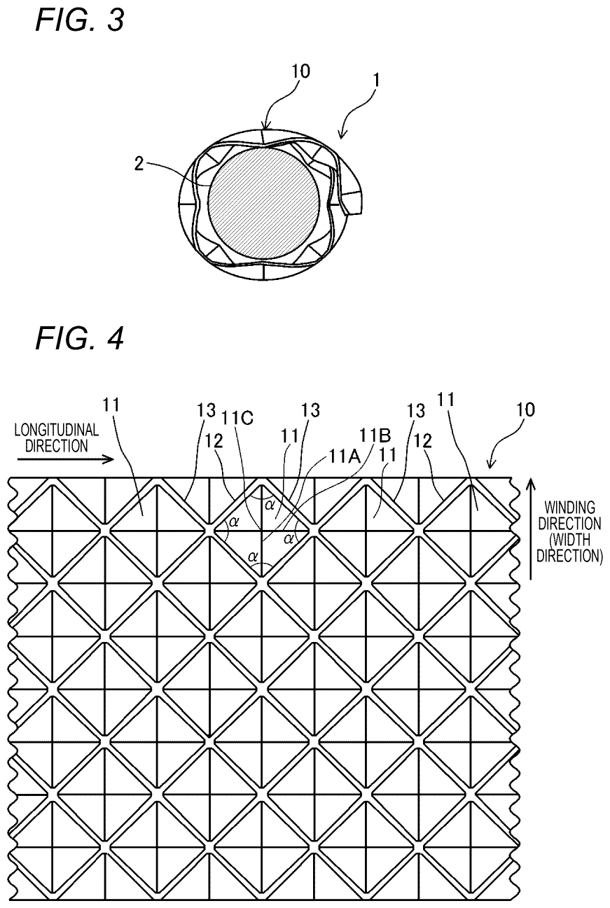

FIG. 1 is a perspective view illustrating a wire harness 1 according to an embodiment of the present disclosure. FIG. 2 is a plan view illustrating the wire harness 1 illustrated in FIG. 1. FIG. 3 is a cross-sectional view illustrating the wire harness 1 illustrated in FIG. 1. The wire harness 1 illustrated in these drawings electrically connects various devices mounted on a vehicle. The wire harness 1 includes an electric wire 2 and an exterior material 10 through which the electric wire 2 is inserted.

The electric wire 2 includes a metal strand (core wire) and an insulating coating layer that coats the metal strand (neither illustrated). The number of the electric wire 2 inserted through the exterior material 10 is one as illustrated or more.

The exterior material 10 is a flexible sheet material formed in a tubular shape by being bent in a width direction by human power, through which the electric wire 2 is inserted in a longitudinal direction. On a surface of the exterior material 10, a plurality of recesses 11 are formed by embossing in a regular and adjacent arrangement in vertical and horizontal directions (width direction and longitudinal direction). Between the adjacent recesses 11, a plurality of ridge lines 12 and a plurality of ridge lines 13 are formed.

Here, after the exterior material 10 is formed into a tubular shape by being bent in the width direction by human power, a force to return to a sheet shape (hereinafter, elastic reaction force) acts on the exterior material 10. For this reason, the exterior material 10 is provided with a plurality of fixing portions 3 including a bundling material, a tape, and the like to prevent the exterior material 10 from being opened in a sheet shape and the electric wire 2 from being exposed. As the elastic reaction force that acts on the exterior material 10 increases, the number of fixing portions 3 provided on the exterior material 10 increases. An assembly property of the exterior material 10 decreases. Further, it is also necessary to ensure flexibility of the exterior material 10 in the longitudinal direction. Therefore, in the exterior material 10 according to the present embodiment, the recesses 11 and the ridge lines 12, 13 are formed as described below for a purpose of restricting the elastic force, improving the assembly property, and ensuring flexibility in the longitudinal direction.

FIG. 4 is a plan view illustrating the exterior material 10 illustrated in FIG. 1 in a spread state. As illustrated in this figure, the width direction of the exterior material 10 is parallel to a winding direction, and the longitudinal direction of the exterior material 10 intersects the winding direction at a right angle. A material of the exterior material 10 is an elastic resin suitable for embossing, and examples of the resin include thermoplastic polyurethane, a silicone resin, polyvinyl chloride, ethylene vinyl acetate, an elastomer, and a polyester-based resin.

The ridges line 12 and the ridge lines 13 are straight lines. The plurality of ridge lines 12 are parallel and equally spaced, and an extending direction of the plurality of ridge lines 12 and the longitudinal direction of the exterior material 10 intersect at an angle of 45°. The plurality of ridge lines 13 are parallel and equally spaced, and each ridge line 12 and each ridge line 13 intersect at an angle of 90°. Here, a plurality of diamond-shaped frame portions are partitioned by the plurality of ridge lines 12 and the plurality of ridge lines 13 in a regular and adjacent arrangement in the width direction and the longitudinal direction of the exterior material 10, and the recesses 11 are formed in the diamond-shaped frame portions.

The recess 11 has a square pyramid shape with a diamond-shaped base surface, and is recessed toward a back surface side of the exterior material 10 in a diamond-shaped space defined by a pair of ridge lines 12 and a pair of ridge lines 13. In the recess 11, a valley portion 11A parallel to the width direction of the exterior material 10 and a valley portion 11B parallel to the longitudinal direction of the exterior material 10 are formed and intersect at an apex 11C.

Here, since each ridge line 12 and each ridge line 13 intersect at an angle of 90°, angles α of four interior angles of a diamond shape defined by the pair of ridge lines 12 and the pair of ridge lines 13 are all 90°(right angle). Accordingly, the angles α of the four interior angles of the recess 11 are all 90°. That is, in each recess 11 of the exterior material 10, the angles α of opposite corners facing each other in the width direction of the exterior material 10 are 90°, and the angles α of opposite corners facing the longitudinal direction of the exterior material 10 are 90°.

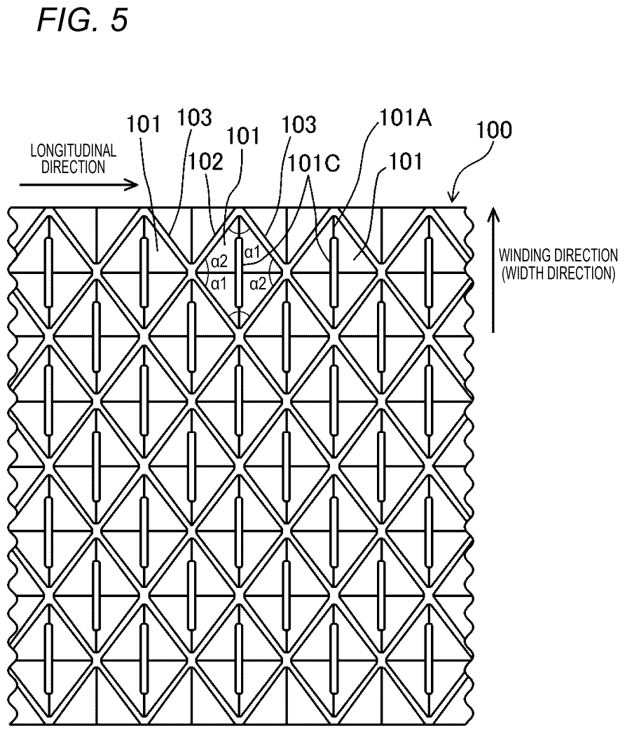

FIG. 5 is a plan view illustrating an exterior material 100 according to a comparative example in a spread state. In the exterior material 100 illustrated in this figure, a horizontal crease 101C is formed in a diamond-shaped recess 101. The horizontal crease 101C is a linear groove formed along a valley portion 101A parallel to a width direction of the exterior material 100. The horizontal crease 101C increases flexibility of the exterior material 100 in a longitudinal direction.

In the exterior material 100, a plurality of diamond-shaped spaces in a regular and adjacent arrangement in vertical and horizontal directions of the exterior material 100 are defined by a plurality of ridge lines 102 and a plurality of ridge lines 103, and the recess 101 is formed in each of the diamond-shaped frame portions. In a diamond-shaped frame portion defined by a pair of ridge lines 102 and a pair of ridge lines 103, angles α1 of opposite corners facing each other in the width direction of the exterior material 100 are smaller than 90°, and angles α2 of opposite corners facing each other in the longitudinal direction of the exterior material 100 are larger than 90°. Accordingly, the angles α1 of the opposite corners of the recess 101 that face each other in the width direction of the exterior material 100 are smaller than 90°, and the angles α2 of the opposite corners of the recess 101 that face each other in the longitudinal direction of the exterior material 100 are larger than 90°.

Here, in the exterior material 100, since the horizontal crease 101C is formed in each recess 101 along the width direction of the exterior material 100, flexibility of the exterior material 100 in the width direction is reduced. For this reason, after the exterior material 100 is formed into a tubular shape by being bent in the width direction by human power, an elastic reaction force that acts on the exterior material 100 increases. Therefore, multiple fixing portions 3 (see FIG. 2) are provided on the exterior material 100. For example, when a length of the exterior material 100 in the longitudinal direction is 300 mm, four fixing portions 3 are necessary, when the length of the exterior material 100 in the longitudinal direction is 600 mm, seven fixing portions 3 are necessary, and when the length of the exterior material 100 in the longitudinal direction is 900 mm, ten fixing portions 3 are necessary. Further, an assembly property of the exterior material 100 decreases.

On the other hand, according to the exterior material 10 in the present embodiment, each recess 11 is formed in a square pyramid shape in which the valley portions 11A, 11B are orthogonal to each other at the apex 11C, and thereby the flexibility of the exterior material 10 in the width direction is increased as compared with the exterior material 100 according to the comparative example. Accordingly, after the exterior material 10 is formed into a tubular shape by being bent in the width direction by human power, an elastic reaction force that acts on the exterior material 10 is restricted. Therefore, the fixing portions 3 provided on the exterior material 10 can be reduced. For example, when a length of the exterior material 10 in the longitudinal direction is 300 mm, the fixing portions 3 are reduced to three, when the length of the exterior material 10 in the longitudinal direction is 600 mm, the fixing portions 3 are reduced to five, and when the length of the exterior material 10 in the longitudinal direction is 900 mm, the fixing portions 3 are reduced to seven.

Further, according to the exterior material 10 in the present embodiment, since the angles α of the four interior angles of each recess 11 are all right angles, the valley portion 11A extending along the width direction of the exterior material 10 and the valley portion 11B extending along the longitudinal direction of the exterior material 10 in each recess 11 have equal lengths. Four sides of each recess 11 also have equal lengths. For this reason, a bending force is uniformly distributed by uniformity of each recess 11 and the ridge lines 12, 13 surrounding each recess 11, and resistance to bending is uniform.

On the other hand, in the recess 11, when the angles α of the opposite corners facing each other in the width direction of the exterior material 10 are larger than 90° and the angles α of the opposite corners facing each other in the longitudinal direction of the exterior material 10 are smaller than 90°, the valley portion 11A is longer than the valley portion 11B, and a shape of the recess 11 is non-uniform. In this case, when the exterior material 10 is bent along the valley portion 11A, the valley portion 11B, which is a shorter diagonal line, is bent, and thus a bending range is narrowed, and a bending force is concentrated. As a result, particularly strong stress is generated near opposite corners on two sides of the valley portion 11A, and resistance to bending increases.

Therefore, according to the exterior material 10 in the present embodiment, the flexibility of the exterior material 10 in the longitudinal direction can be increased as compared with a case where the angles α of the opposite corners facing each other in the width direction of the exterior material 10 are larger than 90° and the angles α of the opposite corners facing each other in the longitudinal direction of the exterior material 10 are smaller than 90°.

The present disclosure has been described above based on the above embodiment, but the present disclosure is not limited to the above embodiment, and modifications may be made to the above embodiment, and publicly known or well-known techniques may be appropriately combined within a scope not departing from the spirit of the present disclosure.

What is claimed is:

1. An exterior material that is a sheet formed with diamond-shaped recesses in a regular and adjacent arrangement in a width direction and a longitudinal direction and that is formed in a tubular shape by being bent in the width direction, wherein
the recesses are each formed in a square pyramid shape, and includes a first valley portion extending along the width direction and a second valley portion extending along the longitudinal direction,
the first valley portion and the second valley portion intersect at an apex of the square pyramid shape, and
four interior angles of each of the recesses are all right angles.

2. The exterior material according to claim 1, wherein
the exterior material is formed with
a plurality of first ridge lines that are parallel to each other and intersect with the longitudinal direction at an angle of 45°, and
a plurality of second ridge lines that are parallel to each other and intersect with the first ridge lines at an angle of 90°, and
the recesses are each formed in a diamond-shaped space defined by a pair of the first ridge lines and a pair of the second ridge lines.

3. A wire harness comprising:
an exterior material that is a sheet formed with diamond-shaped recesses in a regular and adjacent arrangement in a width direction and a longitudinal direction and that is formed in a tubular shape by being bent in the width direction; and
an electric wire inserted through the exterior material, wherein the recesses are each formed in a square pyramid shape, and a first valley portion extending along the width direction and a second valley portion extending along the longitudinal direction,
the first valley portion and the second valley portion intersect at an apex of the square pyramid shape, and
four interior angles of each of the recesses are all right angles.
